(19) United States
(12) Patent Application Publication
(10) Pub. No.: US 2009/0070159 A1
(43) Pub. Date: Mar. 12, 2009

(54) Processing device, a system and a method for providing a message to a user

(76) Inventors: Jouko Ahvenainen, Helsinki (FI); Kimmo Kiviluoto, Helsinki (FI); Janne Sinkkonen, Espoo (FI)

Correspondence Address: ARENT FOX LLP, 1050 CONNECTICUT AVENUE, N.W., SUITE 400, WASHINGTON, DC, 20036, US

(21) Appl. No.: 11/666,913

(22) PCT Filed: Nov. 4, 2005
(86) PCT No.: PCT/FI05/50396

§ 371 Date: May 22, 2008

(30) Foreign Application Priority Data
Nov. 4, 2004 (FI) 20041417

(51) Int. Cl. G06Q 30/00; G06Q 10/00; G06F 9/44

(52) U.S. Cl. 705/7; 705/1; 705/14

(57) ABSTRACT

The present invention relates to a method, a processing device, and a system for providing message(s) to a user of e.g. a mobile terminal. The method comprises receiving a message(s) including an indication in a processing device and retrieving a personal file, which is stored in a personal unit, in the processing device. After receiving the message(s) and the personal profile, the processing device compares the personal profile and the indication. Therefore, in case the personal profile and the indication match, showing the message(s) to the user or in case the personal profile and the indication do not match, not showing the message(s) to the user.

### TECHNICAL FIELD OF THE INVENTION

The present invention relates to a processing device, a system and a method for providing a message(s) to a user. More closely, the present invention relates to the distributed personal profile and the use of it e.g. for message filtering.

### BACKGROUND OF THE INVENTION

The technological development has improved the gain of information of various products and services. People get more and more information from various sources whether by finding that by himself/herself or through advertising campaigns. Especially electronic mail has provided an easy way to advertise products. On the other hand the effectiveness of the electronic mail relies on mass marketing, which also causes a lot of unnecessary sending of mail to people who does not even want to know about some of these products.

Also due to the massive amount of information available for anyone, finding the correct information has become more and more difficult. Since finding relevant information e.g. from the WWW (world wide web) requires sometimes several searches (or browsing several links), a person may give up even to try to find that information.

When a person is trying to find information of some certain product group of interest (e.g. strategy games for a computer), he/she usually tries to find proper pages, i.e. the pages that has information that he/she wishes to find and the pages are updated often enough. After finding these pages, the person needs to manually bookmark them to find them relatively quickly by clicking a set bookmark option or by inserting the web address of the page to his/her bookmarks. Also when the page “dies out” he/she needs to manually remove those bookmarks.

Even though marketing their products to possible customers is very important for companies, there is not easy enough way to target the marketing effort in order to effectively find the people who would be interested of their products or services.

Further, when companies (e.g. chain of stores) wish to market their products to their customers, they may only use their own databases for sending information of offers. The marketing messages (whether through conventional mail, broadcasting, or other marketing) may only be directed to the customers whose profiles are stored in their databases (not e.g. for occasional shopper in a store). For target marketing of special offers to certain customers, the store (or chain of stores) needs to rely on their own databases of their customers' interests (what customers have informed the store e.g. through registration to valued customer program and the possible use of loyalty card when shopping) when targeting offers. Therefore, the store does not even know any of other purchases in other stores or other interests of their customers.

### SUMMARY OF THE PRESENT INVENTION

It is an object of the present invention to overcome or at least mitigate the disadvantages of the prior art. The present invention provides a processing device, a system and a method for providing message(s) to users of e.g. a mobile terminal.

It is an object of the present invention to provide a solution, wherein the information of use of services (i.e. events) is stored in the personal unit of a user. The distributed personal profile enables the real time processing of information.

It is further an object of the present invention to provide a system wherein the personal profile is updated on the basis of earlier events. These earlier events may be e.g. use of a service or purchase of a product.

It is an object of the present invention to provide a solution wherein messages or advertisements are directed efficiently to persons that are interested of them.

It is also an object of the present invention to provide a solution wherein unwanted messages may be filtered with the personal unit. The filtering is based on the learning type solution implemented on the personal unit.

It is further an object of the present invention to provide a solution wherein a hotlist (depending on the users' interests) is automatically generated on the basis of the personal profile and which will adjust automatically when the user changes his/her behavior on using different services.

According to a first aspect of the present invention there is provided a method for providing a message(s) to a user, the method comprising:
receiving a message(s) including an indication in a processing device;
retrieving a personal profile, which is stored in a personal unit, in the processing device;
comparing the personal profile and the indication; and
in case the personal profile and the indication match, showing the message(s) to the user; or
in case the personal profile and the indication do not match, not showing the message(s) to the user.

According to a second aspect of the present invention there is provided a processing device for providing a message(s) to a user, the processing device comprising:
receiving means for receiving a message(s) including an indication in a processing device and retrieving a personal profile from a personal unit;
processing means for comparing the personal profile and the indication; and
display means for showing the message(s) to the user in case the personal profile and the indication match.

According to a third aspect of the present invention there is provided a system for providing a message(s) to a user, the system comprising:
a personal unit comprising a memory for storing a personal profile;
a processing device comprising receiving means for receiving a message(s) including an indication in a processing device and retrieving a personal profile from a personal unit, processing means for comparing the personal profile and the indication, and display means for showing the message(s) to the user in case the personal profile and the indication match; and
a service provider for sending a message(s) to the processing device.

According to a fourth aspect of the present invention there is provided a method for providing a list of links or information to the user in accordance with information of user's preferences as indicated in a personal profile of the user, the method comprising:
retrieving a personal profile from a personal unit to the processing device;
processing the personal profile to sort out the most suitable links or information in the processing device;
arranging the links or information into a list in the processing device in accordance with user's preferences as stored in the personal profile; and
providing the list of links or information to be displayed to the user.

According to a fifth aspect of the present invention there is provided a system for providing a list of links or information to the user in accordance with information of user's preferences as indicated in a personal profile of the user, the system comprising:
a processing device arranged to retrieve a personal profile from a personal unit, to process the personal profile to sort out the most suitable links or information, and to arrange the links or information into a list in the processing device in accordance with user's preferences as stored in the personal profile; and
a display for displaying the list of links or information to the user.

According to a sixth aspect of the present invention there is provided a method for providing recommendations for links to a user, the method comprising:
initiating a request for a service by the user;
providing a personal profile, which stored in a personal unit of the user, together with the request to a service provider;
processing the personal profile by the service provider;
comparing the personal profile to other users' personal profiles by the service provider;
selecting the users with matching personal profile as reference users; and
providing a link or links to other services based on the reference users' choices for next service to the user.

According to a seventh aspect of the present invention there is provided a system for providing recommendations for links to a user, the system comprising:
a user terminal for requesting a service and providing a personal profile from the personal unit together with the request to a service provider;
a service provider having processing means to process the personal profile, to compare the personal profile to other users' personal profiles and to select the users with matching personal profile as reference users and means for providing a link or links to other services based on the reference users' choices for next service to the user.

The dependent claims, as disclosed in the appended claims describe additional features of the embodiments of the present invention.

The present invention provides several advantages when compared to the prior art solutions. In the present invention the personal profile stored in the personal unit comprises behavioral information (e.g. earlier event(s)) of the user, and therefore it is possible to obtain more accurate information for example for risk scoring of trans-actions or filtering unwanted messages. The learning type of personal profile also enables adjustment for unusual behavior of the user of the personal profile. Also real time risk scoring and needed actions may be performed locally, which minimizes the dependency on the central databases and the connections needed for receiving information (and possible risk scoring) from the central databases. The distributed personal profile also reduces the needed capacity on processing the personal information on the central databases. Further, since the personal profile is updated continuously, the services based on the personal profile will adjust automatically when the user changes his/her behavior on using different services. Also the use of personal profile in recommendations (or bookmark) sharing, the recommendations (or bookmark) sharing may be targeted better to right users.

Further advantages of the present invention are described in detailed description of the embodiments of the present invention with reference to the drawings.

### BRIEF DESCRIPTION OF THE DRAWINGS

For a better understanding of the present invention and in order to show how the same may be carried into effect reference will now be made to the accompanying drawings, in which:

FIG. 1 shows an inventive concept of the present invention.

FIG. 2a shows an embodiment of the personal unit and the processing device according to the present invention.

FIG. 2b shows an embodiment of the present invention.

FIG. 2c shows an alternative embodiment of the present invention.

FIG. 3 shows an alternative embodiment of the present invention.

FIG. 4 shows an alternative embodiment of the present invention.

FIG. 5 shows a flow chart illustrating the process of the inventive concept of the present invention.

### DETAILED DESCRIPTION OF CERTAIN EMBODIMENTS

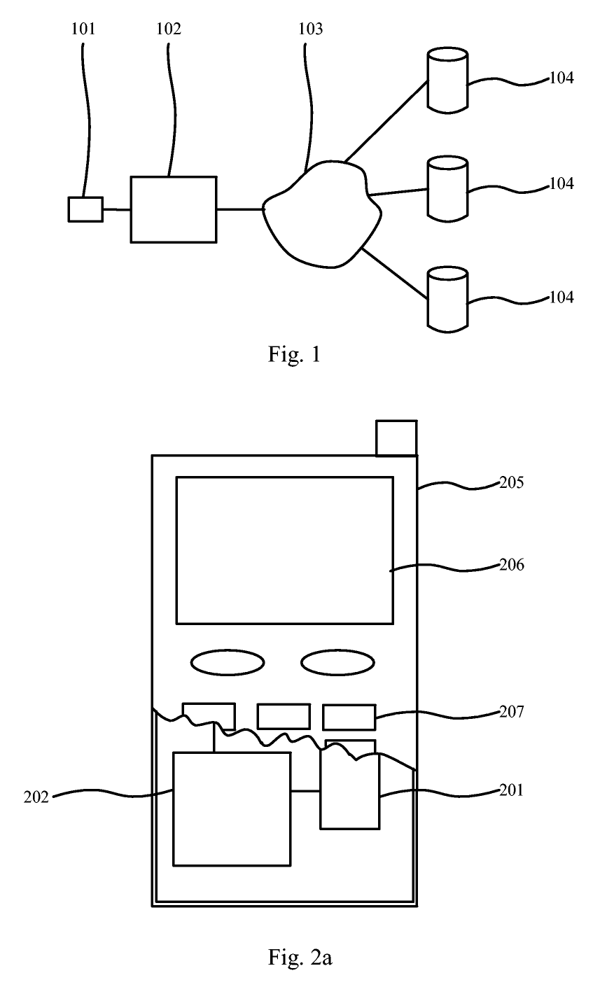

FIG. 1 shows an inventive concept of the present invention. In FIG. 1 there is shown a system comprising a personal unit 101 of a customer or a user, a local device (a processing device) 102, a communications network 103, and several companies 104 (three of which are shown in FIG. 1) connected to the communications network 103.

In the inventive concept of the present invention there is stored a user's personal profile in a memory (not shown in FIG. 1) of the personal unit 101. In the following presentation the personal unit 101 may be a smart card, a file or a memory in a computer, a smart card or a memory in a mobile terminal, or a smart card or a memory in a digital-TV terminal. The smart card may be implemented e.g. in a credit card, loyalty card or SIM (Subscriber Identity Module). The smart card is specified more closely e.g. in ISO/IEC 7816 standards (defining physical shape, functionality, etc.).

The personal profile according to the inventive concept of the present invention comprises information of typical behavior of personal unit 101 user (and possibly also some additional information such as demographic information), which may be utilized to reveal unusual use of personal unit and targeting e.g. sales offers to the users. The information of typical behavior comprises events (e.g. purchases or use of services) performed by the user with his/her personal unit 101. The information may be about e.g. what kind of products the user has bought from stores, what services the user has used through an Internet, and information of when (e.g. what weekday and whether in the morning or in the evening) and where (i.e. certain geographical area) the event(s) has (have) taken place. The information in the personal profile may be categorized in several categories. Some of the categories may relate to hobbies, daily products purchases, etc.

The local device 102 (or processing device or processing means) according to the present invention may comprise a mobile terminal, a computer, a digital-TV terminal, a card reader, a cash register, or an ATM (Automatic Teller Machine). The personal unit 101 may be in direct contact (for example SIM card in a mobile terminal) or in indirect contact (for example a smart card communicates e.g. through wireless technology with a card reader) to the local device 102.

The communications network 103 according to the present invention may be a LAN (Local Area Network), an Internet, a data network, or a circuit network. The communications network 103 provides the communication between the local device 102 and the companies 104. Therefore it is not important how the network is constructed but the capability of transferring the required data between the local device 102 and the companies 104 (for example service providers in the Internet).

Even though the present invention discusses of companies (indicated as 104 in FIG. 1), they also covers the database(s) and processing means located at company premises (or in connection thereto). Usually, for example, chain of stores comprises a centralized database and processing systems for storing and processing information of their valued customers (the information may have been collected e.g. through application forms that customers have filled). The same may be applied for mobile telephone operators, Internet Service Providers (ISPs), service providers in the Internet, etc.

In the inventive concept according to the present invention, the functioning may be described as following.

The personal profile is created and stored in the personal unit 101. The personal profile may be created by the user (the personal profile then comprises interests, etc. defined by the user) and/or the personal profile may be created gradually when events (purchases and/or use of services) have taken place. In preferred embodiment, the personal profile is created on the basis of both of the above.

As a first step, an event is initiated. The event initiation may be for example receiving a message (e.g. marketing message) in a local device 102. Further alternative is when the event is initiated by providing the personal unit 101 into proximity of a card reader (e.g. when a bus fair is intended to be paid with a smart card).

Thereafter the connection between the personal unit 101 and the local device 102 is established. The connection establishing may be utilized by providing a direct contact (e.g. by inserting a SIM card into a mobile terminal) or an indirect contact (e.g. by providing a smart card into proximity of a card reader and providing a communication through wireless technology) between the personal unit 101 and the local device 102.

When the connection between the personal unit 101 and the local device 102 is established (or at the establishing phase), the personal profile is transmitted from the personal unit 101 to the local device 102. After receiving the personal profile, the local device 102 processes the personal profile to define previous purchases or use of services and/or possible restrictions and/or demographic information and/or interests defined in the personal profile. The local device 102 may further request additional information from a central database of some company 104 to define the validity of the personal unit 101. This additional information request is not mandatory in most of the embodiments of the present invention and therefore it should be considered as additional feature to the present invention.

After processing the personal profile (and possible additional information received from the database), the local device 102 compares the current event to the information received from the processed personal profile.

The comparison may be implemented in the following way. A probability of proper event is calculated based on density of events (for example 100 or so events stored in the personal profile), wherein the events are multiplied by a weighting value. In case the calculated probability is above a certain predefined level, the current event is (most likely) considered as proper use of personal unit 101, and vice versa. The comparison may also be implemented with a system in which the results would indicate opposite meaning (i.e. result is based on constants or weights used in the calculation).

The local device authorizes or denies the event, on the basis of the above comparison, whether automatically or informs the local device 102 user that the event should be denied.

In case of successful event (e.g. use of a service), the local device 102 updates the personal profile and store it in the personal unit 101 of the user.

One form of the above description relates to sending marketing messages (or alike) from some company 104 to some area (e.g. broadcasting). In this case the processing means of the company attaches in the message an identification for what kind of profiles the message is targeted. When the local device 102 (e.g. a mobile terminal) receives the message with the indication of profiles, the local device 102 requests the personal profile from the personal unit 101. After receiving the personal profile from the personal unit 101, the local device 102 compares the personal profile and the indication in the message. If the comparison result (the calculation may follow the above calculation for probability of an event) is that the profiles match, the local device 102 processes the message so that the personal unit 101 user may view it. On the other hand if the personal profile and the indication of profiles in the message do not match, the local device 102 ignores the message (i.e. does not further process the message).

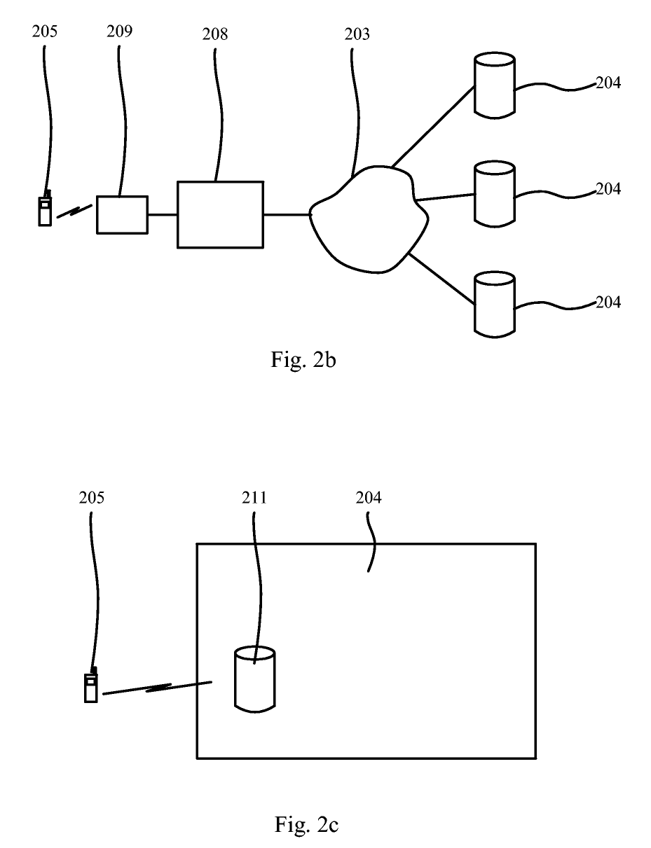

In the following a more detailed examples are described with reference to FIGS. 2a to 4.

FIG. 2a shows an embodiment of the personal unit and the processing device according to the present invention. FIG. 2a shows a mobile terminal 205 and a SIM (Subscriber Identity Module) card 201 inserted in the mobile terminal 205. There is also processing means 202 implemented in the mobile terminal 205.

The SIM card 201 may be utilized to store personal profile according to the present invention. The personal profile may include e.g. demographic data (such as age) of the SIM card owner and/or information of possible use of service(s) (whether by calling a service number or by connecting to a service through a data network).

Even though the following description (with reference to FIGS. 2a to 2c) illustrates that the personal profile is stored in a SIM card and the processing means are on the mobile terminal, the skilled person in the art realizes that the personal profile and the processing means could be in the same unit. The modern smart cards also include processing capability which may do the processing, and in that case the memory for storing the personal profile and the processing means can be implemented to the SIM card. On the other hand the personal profile could be stored in the memory of the mobile terminal, and in this case the personal profile and the processing means can be implemented to the mobile terminal.

The processing means 202 of the mobile terminal 205 is able to process the personal profile and also to update the personal profile in accordance with used services (also covering call and message services) and when they have taken place. Therefore it is possible to modify the personal profile stored in the SIM card 201. This way the personal profile will adjust according to used services.

The personal profile may also be used to avoid showing same messages (e.g. advertisements) more than once to the user.

The mobile terminal 205 also comprises e.g. a display 206 for displaying information to the mobile terminal user and keys 207 so that the user may control input information and make choices.

The use of the mobile terminal 205 in accordance with the present invention is illustrated in the following with reference to FIGS. 2b and 2c.

FIG. 2b shows an embodiment of the present invention. In FIG. 2b there is shown a mobile terminal 205 connected to a node 208 (of a mobile network operator). The mobile network operator preferably provides a connection to a data network 203, through which the mobile terminal 205 user may connect to various services (three service providers 204 are illustrated in FIG. 2b) provided by the data network 203.

The mobile terminal 205 may be connected through an air interface to a Base Station 209 (or alike means for providing a connection between the mobile terminal and the node), which in turn is connected to the node 208 (of the operator) through e.g. Base Station Controller (not shown in FIG. 2b) and other network nodes. Operation of the mobile network (and also the connections between the mobile terminals and network nodes) are well defined in mobile network standards e.g. defined by ETSI and ITU, and therefore they are not described more closely herein.

In this embodiment of the present invention, the mobile terminal 205 may be connected to various services (only three service providers 204 are shown in FIG. 2b). The skilled man in the art realizes that even though there are used only three service providers to illustrate the inventive concept of this embodiment of the present invention, there is in reality a plurality of service providers 204 connected to e.g. WWW (World Wide Web).

In this embodiment of the present invention it is possible to utilize message filtering on the basis of the information included in the personal unit (a SIM card 201 in this embodiment).

The message filtering management may be utilized e.g. in the following way. A personal profile according to the inventive concept of the present invention is stored in the SIM card 201. The personal profile comprises information of the used services (behavioral information) and possible information of the interests (and demographic information) of the user of the mobile terminal 205.

A service provider 204 sends a message to a certain area (e.g. a city). The message includes an offer to some service and also indication for what kind of profiles the offer is directed to. The message is transmitted through a communications network 203 and mobile network nodes (208 and 209) to the mobile terminals in that area. Alternatively the message is sent from the mobile network node 208 through a BS 209 to mobile terminals 205 in that area.

After receiving the message in the mobile terminal 205, the processing means 202 of the mobile terminal 205 retrieves the personal profile from the SIM card 201.

Thereafter, the processing means 202 compares (the comparison may be implemented by calculating a probability as described with reference to the inventive concept of the present invention) the information in the personal profile to the indication received within the message. In case the personal profile and the indication for what kind of profiles the message is directed to matches, the processing means 202 processes the message and shows the message to the user of the mobile terminal 205. However in case the indication does not match with the personal profile, the processing means does not show the message to the user but considers that the message is directed to some other mobile terminals 205.

In case the sent message is shown to the user, the processing means 202 of the mobile terminal 205 may add the event (i.e. offered service) to the personal profile, which is then stored to the SIM card 201.

The above described personal profile may also be utilized for web content filtering in the following way.

The personal profile stored to the SIM card 201 corresponds to the above. When the user of the mobile terminal connects to certain web service (e.g. a web page of a service provider) containing e.g. advertisements on the service, the processing means 202 of the mobile terminal 205 receives the content of the service and indications of advertisements for what kind of profiles the advertisements are directed to.

Thereafter the processing means 202 processes the personal profile retrieved from the SIM card 201, and compares the indications to the processed personal profile. In case the comparison result is that indication and personal profile matches, the processing means 202 further processes those advertisements that contained indications matching the personal profile so that the mobile terminal 205 user may view the advertisements. Otherwise in case the indication does not match with the personal profile, the processing means 202 does not further process those advertisements to be shown to the mobile terminal 205 user.

After showing the content of the service, the personal profile may be updated by the processing means 202 of the mobile terminal 205 e.g. with the information for what advertisements the user has chosen (e.g. clicked). The updated personal profile is then stored to the SIM card 201.

The described message and web content filtering is especially convenient since the personal profile is stored in the SIM card 201 of the mobile terminal 205. Therefore when another mobile terminal (not shown in FIG. 2b) is used with the same SIM card 201, the filtering options are ready to use.

Even though the above embodiments of the present invention describes the system in specific terms (e.g. SIM card 201), the skilled man in the art realizes that the same implementation may be utilized to systems with different elements as long as they functions in similar manner. For example the services may be call services instead of web services.

Also the above mentioned personal profile may be utilized for target marketing (when the mobile terminal user/owner permits such actions). In target marketing the node 208 receives the personal profile and thereafter whether it processes the personal profile or transmits the personal profile to other processing means (not shown in FIG. 2b). When the personal profile is processed there may be analyzed the interests of the user (and the marketing messages may be send to interested users). The privacy may be improved by utilizing the personal profile such that there is no name or such information (address) included in the personal profile, i.e. the person may be indicated e.g. merely by a number (e.g. 123456). This also reduces the memory capacity needed for storing the personal profile.

An alternative embodiment of the present invention covers the provision of a hotlist(s) (e.g. a list of links to services) to the mobile terminal users. In this embodiment of the present invention, there is provided a hotlist of certain services (e.g. a web page or a calling number) to the user of the mobile terminal. This may be provided in the following way. Every time the user of the mobile terminal selects a service, information of what service has been selected, when (time) it was selected and in what location (this feature is possible in mobile terminals e.g. through using the positioning information of the mobile terminal defined by the mobile network) it has been selected, the personal profile stored in the SIM card is updated with the information. When the user initiates that he/she will make a request for some service (for example selecting a starting page for web browsing), the processing device (in this case the mobile terminal) retrieves the personal profile. After retrieving the personal profile, the processing device processes the personal profile to extract information regarding what services the user has chosen (e.g. by clicking a link), when and where. The hotlist may be arranged e.g. depending on clicking density or depending on user's behavioral use of the services.

In case the hotlist is to be arranged depending on the clicking density, the processing device extracts the information how often the user has clicked a certain link. It is also possible to give weighting values for time periods when calculating the density. This eliminates for example showing in a hotlist a link that the user has not clicked for example in the recent year. The forming of the hotlist is done by processing the personal profile to sort out the most suitable links (in this case the most often used links), whereafter the processing device arranges the links into a list in accordance with the user's preferences as stored in the personal profile. After forming the hotlist, the processing device provides the hotlist to the display of the mobile terminal so that the user may select a direct link in the hotlist.

In case the hotlist is to be arranged depending on user's behavioral use of the services (also covering the time and place of using the services), the processing device may sort the information from the personal profile for example in the following way.

If the user of the mobile terminal usually reads the morning news (from two different sources) on the way to work every Wednesday morning around 9 o'clock, the mobile terminal can create a hotlist showing these two links in top of the list every Wednesday around 9 o'clock (when the web service is initiated) in the mobile user's home town. This is enabled by utilizing the behavioral information of the user stored in the personal unit. The behavioral information in this case comprises the information of the time (Wednesday 9 o'clock), place (home town) and what services (two news services) are used. However, in case the time or place is different from the usual use of these services, the processing device (the mobile terminal) is able to modify the list. For example if the above services are local services but the person is in another country on that specific time period, the processing device does not list these links to the hotlist.

Even though the above considers of creating a hotlist of e.g. links to the web pages, the same processing may be used for various services with the same implementation as described above. For example, choosing a radio channel on a mobile terminal by utilizing the information of the user's usual behavior on choosing the channels. Further, the information on the personal profile may be utilized for finding proper products e.g. in a web store or finding a service or finding information that match the user's interests. Therefore, links comprises also products or any other information.

By providing the hotlist to the user of the mobile terminal, the user may avoid clicking different links several times before the correct web page is found.

The above provision of hotlist to the user is performed in an automatic manner, i.e. the user does not need to define those links that are shown in the hotlist. Further, since the hotlist is based on the information stored in the personal profile (which is continuously updated), the hotlist will adjust automatically when the user changes his/her behavior on using different services (e.g. changing from one news service into another during a period of time).

Another alternative embodiment of the present invention covers the provision of recommendations to the mobile terminal user. The personal profile of the mobile terminal user is created from the history of using services (behavioral events) and demographic information and/or user defined information.

When the user initiates a request for a certain service, the personal profile may be sent together with the request. After receiving the request and the personal profile the service provider may compare the characteristics of the personal profile to other user's personal profiles. In case the service provider finds a match (when comparing the personal to other user's personal profiles) between the current user's personal profile and some other user's personal profile (the users with matching personal profile may be selected as reference users), the service provider can recommend next possible service(s) by sending information (or links to services) what services other users with same kind of personal profiles (which is based on use of services and personal interests) has used after this service. This way users with similar interests may find information of other service(s) they may not even know that could interest them or how to find them directly.

When selecting a service the time and place may affect to the recommendations. For example if the reference user next chooses web pages of a sports goods store in London and the user to whom the recommendations are sent is in Berlin, the recommendation may be changed to web pages of a sports goods store in Berlin.

FIG. 2c shows an alternative embodiment of the present invention. This embodiment of the invention covers utilizing the information in the personal profile stored in a memory means (hereinafter SIM card) 201 of the mobile terminal 205.

A personal profile, which is stored in the SIM card 201 of the mobile terminal 205, has been created in the mobile terminal 205 on the basis of use of the mobile terminal 205 (e.g. on the basis of the used services) and/or interests of the user (may be added by the user). The personal profile includes interests of the user and possible demographic information. The profile may also be updated by the use of the mobile terminal 205 for some services e.g. in the web.

A store 204 processing means 211 may send continuously (or periodically) messages (e.g. offerings) through an air interface nearby (i.e. within a certain range from) the store 204. The messages include indication for what kind of profiles the messages are directed to.

When a mobile terminal 205 user walks on the street nearby the store 204, the mobile terminal 205 may receive messages from the processing means 211 of the store 204. After receiving a message in the mobile terminal 205, the processing means 202 of the mobile terminal 205 processes the indication in the message and the personal profile stored in the SIM card 201, and compares the indication(s) in the message(s) to the personal profile.

In case there is a match between the indication and the personal profile, the processing means 202 of the mobile terminal 205 authenticates the event, i.e. shows the message to the mobile terminal 205 user. On the other hand in case the indication(s) does not match to the personal profile, the processing means 202 denies the event, i.e. does not further process and show the message to the user of the mobile terminal 205.

The above sending of messages (or offerings) may also be implemented within the store on the same manner as described above.

The air interface between the store processing system 211 and the mobile terminal 205 may be implemented e.g. by means of Bluetooth connection.

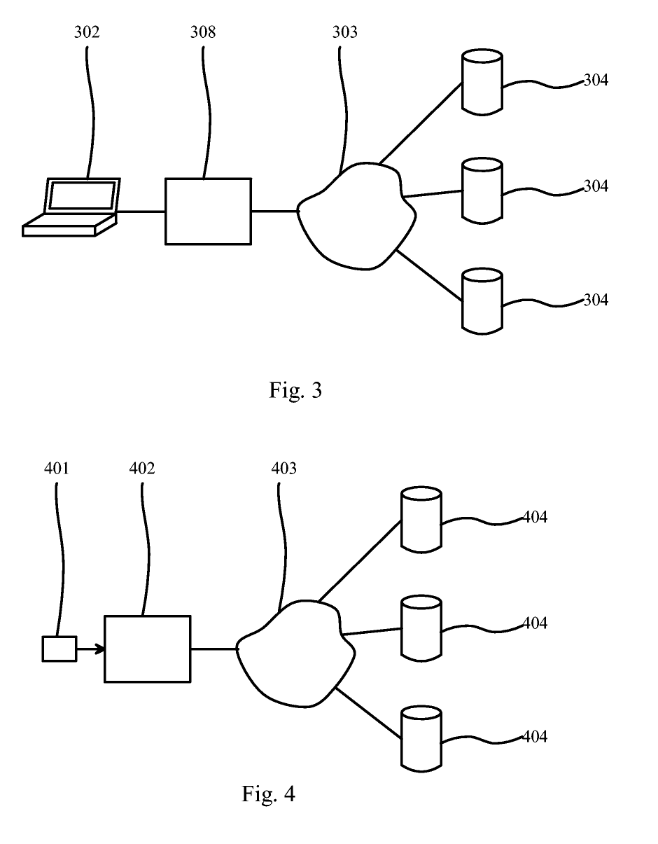

FIG. 3 shows an alternative embodiment of the present invention.

In this embodiment, the personal unit is a file stored in memory means of a computer 302. The file may be modified by the processing means of the computer 302 so as to update the information on the file. This embodiment may be utilized to filter web content or message (e-mail) filtering.

The computer 302 according to this embodiment of the invention is connected to network services 304 through a communications network 303. The communications network may be for example an Internet or a LAN (Local Area Network).

The personal profile may be updated on the basis of the use of the web services 304 or on the basis of the users own wishes (i.e. the user may update the interests into the personal profile). The information for updating the personal profile is processed by the processing means of a computer 302, and the updated file is thereafter stored in the memory means of the computer 302.

The personal profile according to this embodiment of the present invention may be utilized for content or message filtering in a similar manner as described with reference to FIG. 2b.

The message or content filtering may be performed in the following manner.

The personal profile (according to the inventive concept of the present invention) is stored in a file in the computer 302. A company sends a message (including an indication for what kind of profiles the message is directed to) to an e-mail address of the user. After receiving the message, the processing means of the computer 302 processes the received message and a personal profile. The indication in the message is thereafter compared to the profile of a user of the computer 302. In case the indication matches the personal profile of the user, the processing means of the computer 302 shows the message to the user. In case the indication and the personal profile do not match, the processing means of the computer does not show the message to the user but deletes it from a mailbox (of the user).

As for the content filtering, the process may be performed in the following way.

When the user of the computer 302 makes a request for entering certain service (located in a service provider's 304 node) through a network node 308 (usually an Internet Service Provider) and communications network 303, the service is sent to the computer 302. The service may contain attached therein e.g. advertisements wherein an indication for what kind of profiles the advertisement is directed to. After receiving the service in the computer 302, the processing means of the computer 302 processes the received content and identifies the indications therein. The computer 302 also processes the personal profile. After identifying the indications, the computer 302 compares the personal profile to the indications in the service.

In case there is found indications (in relation e.g. to advertisements) in the service corresponding to the personal profile, the processing means of the computer 302 further processes these parts of the service (i.e. processes the advertisements including indications corresponding to the personal profile) and shows them to the user of the computer 302. Those advertisements including indications that do not match with the personal profile are not shown to the user of the computer 302.

The personal profile may be updated on the basis of e.g. clicking a link whether in the service or in the message (e.g. an advertisement link). The update is performed by adding the indication to the personal profile and saving it as a new file in the computer 302.

The hotlist(s) and the recommendations disclosed more closely with reference to FIG. 2b may also be implemented easily to the above computer system, since the personal profiles of the mobile terminal and the computer system functions in similar manner. Since applying the means of the computer system disclosed with reference to FIG. 3 to what is described with reference to FIG. 2b (with regard to hotlist(s) and recommendations) results similar results, the process is not repeated herein more closely.

FIG. 4 shows an alternative embodiment of the present invention.

In this embodiment of the present invention, there is shown a digital television system, which comprises a personal unit (e.g. a digital TV card) 401, a processing device (e.g. a set top box or a television receiver) that is a digital-TV terminal 402, a broadcast network 403, and a service provider 404. The personal profile is stored in memory means, wherein the memory means are located (or connected to) in a digital-TV terminal. The digital-TV terminal 402 updates the personal profile according to the watching habits and/or information that the user of the digital-TV terminal 402 chooses to insert to the personal profile.

When the digital-TV terminal 402 is turned on, the digital-TV terminal 402 receives the personal profile from the personal unit 401 and processes the received information. When processing the personal profile, the digital-TV terminal 402 checks the categories of the programs (or added services) that are favored by the user. After the personal profile is processed, the digital-TV terminal 402 checks the program information (which may be considered as a message or messages as disclosed with reference to FIGS. 2a to 3) broadcasted by the service provider 404 through the broadcast network 403. The program information can comprise indications for what kind of program is broadcasted and when. Alternatively the digital-TV terminal 402 comprises intelligence to categorize the broadcasted programs into different categories (e.g. comedy series, quiz shows, news).

The digital-TV terminal 402 compares the personal profile to the indications or categories of programs that are broadcasted. When the comparison is performed, the digital-TV terminal 402 may recommend a program that is currently broadcasted or show a hotlist for that night's programs. The provision of a hotlist to the viewer (or user) follows the process as described with reference to the mobile terminal, and therefore, it is not disclosed more closely herein. The hotlist may be arranged so that the most accurate matches to the personal profile are shown on top (e.g. programs that the user always watches) and the least accurate matches are shown in the bottom of the list (e.g. if the user of the digital-TV terminal rarely watches drama movies, these might be shown here). The arrangement of the hotlist may be based on the digital-TV terminal manufacturer or the user may even modify the hotlist as he/she wants it to be shown to him/her.

In addition to the above embodiment, the digital-TV terminal 402 may be arranged to remind the user of the programs that are often watched by the user. The most viewed programs can be processed from the personal profile.

In another embodiment of the present invention, the digital-TV terminal 402 can filter the program content that may be watched or the available services that may be used. This may be done in a similar manner that has been disclosed with reference to the FIGS. 2a to 3, except the processing device in this case is the digital-TV terminal. By using the filtering option, the user may filter unwanted advertisements or block certain type of programs to be watched (for example to block the movies containing violent acts so that children can not watch them).

In another embodiment of the present invention, the advertisement targeting may be improved in the following way. The broadcasting company may broadcast several streams of advertisements on one channel. Every stream has its own identification for what kind of profiles the stream is intended to be shown. The digital-TV terminal 402 identifies the stream automatically (after performing a comparison between the identifications and the user profile) on the basis of the personal profile (when comparing the identification and the personal profile) stored in the personal unit 401 and shows the specific stream to the viewer. In this way the broadcasting company may target the advertisements or services to the viewers that are interested of such products or services. This also reduces broadcasting unnecessary advertisements or information of services to those digital-TV terminal 402 users that are not interested in such products or services. Alternatively, every commercial (corresponding to the message(s) as disclosed with reference to FIGS. 2a to 4) includes an indication which is compared to the personal profile. The commercial (when broadcasting at least two different alternative commercials at the same time) having an indication that best matches to the personal profile is shown to the viewer.

By providing a commercial that matches the viewer's interest, the effectiveness of the marketing may be increased.

In an alternative embodiment of the present invention the personal unit is a smart card attached to a credit or loyalty card. On the following the card is indicated as loyalty card for exemplary purposes only and the same could be applied in general to the credit card (or another card for storing earlier events and enabling the utilization of such information).

The loyalty card comprises a smart card (integrated chip) whereto information may be stored. The smart card functions as the memory of the loyalty card. The information may include information of the owner of the loyalty card (e.g. demographic information such as age). The information may also include the personal profile of a user according to the inventive concept of the present invention.

The personal profile according to this embodiment of the present invention comprises information of earlier events (purchases and/or use of the card). This information may be for example information of earlier purchases in different stores. In this case the information may include what kind of product was purchased, where it was purchased, and when it was purchased. In general the information that is utilized in this embodiment of the present invention includes typical behavior of the use of the loyalty card. The information comprises e.g. when and where the user of the loyalty card does his/her daily groceries purchases, etc.

In this embodiment of the present invention the process may be illustrated in the following way.

When a user of a loyalty card wishes to pay his/her purchase(s), the loyalty card is inserted into a processing device of a shop. After the insertion of the loyalty card, processing device (e.g. a card reader) retrieves the personal profile from the memory (or smart card) of the loyalty card.

In case the shop has a communications system for providing special offers to the customers, they may provide these offers with indication for what kind of profiles they are directed to the processing devices. Thereafter the processing device compares the personal profile and the indication in the offer. If the personal profile and the indication match, the offer or an advertisement may be shown to the customer in a display.

The personal profile may also be used for fraud detection by comparing current purchase to the personal profile, since the personal profile indicates the usual behavior (including what kind of purchases, time and place of the purchases the customer usually does) of the card holder.

The indication of possible fraud may be calculated by giving certain (weighting or probability) values for each earlier event and multiplied with density of such events. These values may be categorized with different ways to the personal profile. After performing the calculation, the local device may gain certain value indicating the likelihood of proper purchase (the system may be such that values under certain limit are considered as being likely a fraud and values over the limit are likely proper use of the credit card).

After processing the comparison the processing means of the processing device may notify the cashier of possible fraud, deny automatically the purchase or authenticate the purchase.

After processing the personal profile the processing device may be implemented to update the personal profile with the occurred event. In this way it is possible to have the personal profile in real-time in the loyalty card.

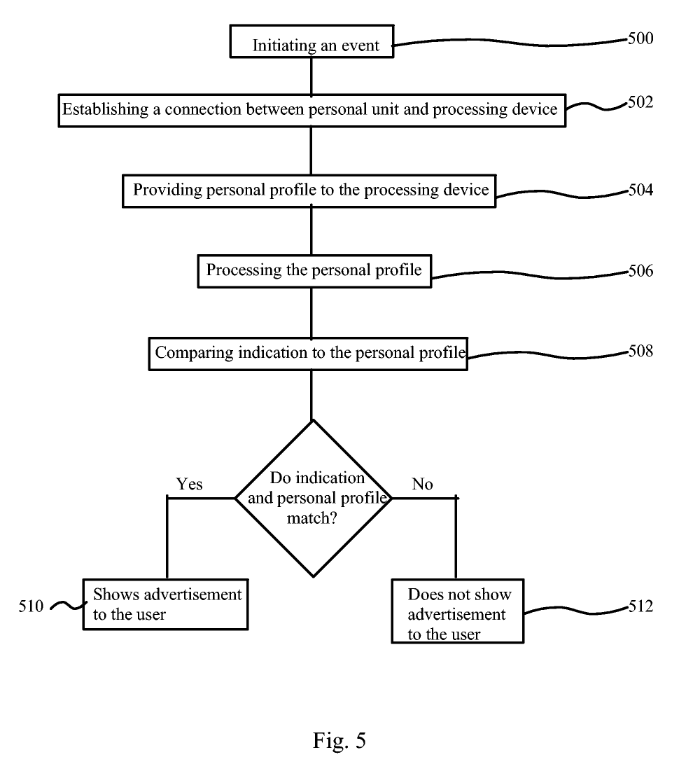

FIG. 5 shows a flow chart illustrating the process of the inventive concept of the present invention.

The process starts with initiation of an event, step 500. The event may be initiated by inserting a smart card to or close proximity to a card reader or by initiating a connection from a mobile terminal to a network or by receiving a message or content from a network.

After initiating (or at the same time) the event, a connection between a personal unit and a processing device is established, step 502. The connection may be established by forming a connection between a SIM card and a mobile terminal, by providing a smart card into close proximity to the card reader (so that air communication is enabled between the smart card and the card reader), by retrieving a file into processing means of a computer, or by inserting a smart card into a card reader. After the connection is established, a personal profile may be provided (or transmitted) from the personal unit to the processing device, step 504. The personal profile is according to the inventive concept of the present invention (as described with reference to FIG. 1).

The processing device processes the personal profile after receiving it from the personal unit, step 506. Thereafter, the comparison between the current event (e.g. an indication of an advertisement) and the personal profile is performed, step 508. The processing and comparing is performed as described in the inventive concept of the pre-sent invention (as described with reference to FIG. 1).

After receiving the comparison result, if the indication and the personal profile match, the processing device shows e.g. an advertisement to the user, step 510. If the indication and the personal profile do not match, the processing device does not show the advertisement (or alike) to the user, step 512. The received event may also be e.g. a digital-TV program, wherein the indication refers to the category (e.g. comedy series or drama movie).

In case the event is successfully implemented, the current event may be stored as one event to the personal unit. The update may need that the processing device processes the information of the event and adds that information to the personal profile and whereafter the ‘new’ personal profile is stored to the personal unit.

It will be appreciated by the skilled person in the art that various modifications may be made to the above described embodiments without departing from the scope of the present invention, as disclosed in the appended claims. For example, the processing means may receive a plurality of messages (e.g. offerings) at the same time, which are thereafter processed (filtered) by the processing means of the user. Also the above embodiments for filtering messages (e.g. advertisements) may also be utilized to digital television, wherein the memory means are located (or connected to) whether in the television receiver or in the set top box. Also instead of using SIM card in a mobile terminal, also other memory means may be implemented (e.g. memory of the mobile terminal itself or other card providing possibility to store the information of the events). Still further there is implemented solutions wherein the mobile terminal is provided into close proximity (or in connection) of the card reader for e.g. paying a fare (the utilization of so called near field communication technology), and therefore the connection may be implemented also in that way in the inventive concept of the present invention.

1. A method for providing a message(s) to a user, the method comprising:
receiving a message(s) including an indication in a processing device;
retrieving a personal profile, which is stored in a personal unit, in the processing device;
comparing the personal profile and the indication; and
in case the personal profile and the indication match, showing the message(s) to the user; or
in case the personal profile and the indication do not match, not showing the message(s) to the user.

2. A method according to claim 1, wherein the indication is an indication for what kind of profiles the message is directed to.

3. A method according to claim 1 or 2, wherein the message is an offer or an advertisement on a web page or an e-mail or a digital-TV program or a television advertisement.

4. A method according to any one of the preceding claims, wherein the method further comprises updating the personal profile with an event.

5. A method according to any one of the preceding claims, wherein the personal profile comprises typical behavior of the personal unit user in the form of earlier events performed with the personal unit.

6. A method according to claim 5, wherein the personal profile further comprises demographic information and/or user defined information of the user.

7. A method according to any one of the preceding claims, wherein the message is received from a web service when connecting thereto.

8. A method according to any one of claims 1-7, wherein the message is received via an air interface from a processing system of a store.

9. A method according to any one of the preceding claims, wherein the personal unit is a SIM (Subscriber Entity Module) card or a file in a memory means of a mobile terminal and the processing device is a mobile terminal, and a connection between the SIM card and the mobile terminal is established through connecting means of the mobile terminal.

10. A method according to claim 9, wherein the message is shown to the user of the mobile terminal by displaying the message in a display of a mobile terminal.

11. A method according to any one of the preceding claims, wherein the message(s) is received from a service provider and is transmitted through a communications network and mobile network node(s).

12. A method according to any one of claims 1-7, wherein the personal unit is a file stored in a computer and the processing device is a processor of a computer.

13. A method according to any one of claims 1-7, wherein the processing device is a digital-TV terminal.

14. A method according to claim 13, wherein the message is received from a service provider through a broadcast network.

15. A method according to any one of claims 1-7, wherein the personal unit is a loyalty card or a credit card and the message is shown to the user through a display connected to the processing device.

16. A method according to any one of the preceding claims, wherein the processing device retrieves further information of the personal unit from at least one database.

17. A method according to claim 16, wherein the further information of the personal unit is retrieved from the database(s) through a communications network, wherein the communications network is one of the following: a LAN (Local Area Network); an Internet; a data network; and a circuit network.

18. A processing device for providing a message(s) to a user, the processing device comprising:
receiving means for receiving a message(s) including an indication in a processing device and retrieving a personal profile from a personal unit;
processing means for comparing the personal profile and the indication; and
display means for showing the message(s) to the user in case the personal profile and the indication match.

19. Processing device according to claim 18, wherein the processing means further comprises means for updating the personal profile.

20. Processing device according to claim 18 or 19, wherein the processing device is a mobile terminal arranged to read the personal profile from the personal unit.

21. Processing device according to claim 18 or 19, wherein the processing device is a computer which is arranged to read the personal profile from the personal unit.

22. Processing device according to claim 18 or 19, wherein the processing device is a digital-TV terminal which is arranged to read the personal profile from the personal unit.

23. A system for providing a message(s) to a user, the system comprising:
a personal unit comprising a memory for storing a personal profile;
a processing device comprising receiving means for receiving a message(s) including an indication in a processing device and retrieving a personal profile from a personal unit, processing means for comparing the personal profile and the indication, and display means for showing the message(s) to the user in case the personal profile and the indication match; and
a service provider for sending a message(s) to the processing device.

24. A method for providing a list of links or information to the user in accordance with information of user's preferences as indicated in a personal profile of the user, the method comprising:
retrieving a personal profile from a personal unit to the processing device;
processing the personal profile to sort out the most suitable links or information in the processing device;
arranging the links or information into a list in the processing device in accordance with user's preferences as stored in the personal profile; and
providing the list of links or information to be displayed to the user.

25. A method according to claim 24, wherein the processing device automatically processes the personal profile and arranges the links or information.

26. A method according to claim 24 or 25, wherein the links or information are arranged in accordance with the previous use of the links or content relating to information.

27. A method according to claim 24 or 25, wherein the links or information are arranged in accordance with the time and place of processing the list.

28. A method according to any one of claims 24 to 27, wherein the links are links to a service, such as a calling service number or a web address.

29. A method according to any one of claims 24 to 27, wherein the information is information of a digital-TV program.

30. A system for providing a list of links or information to the user in accordance with information of user's preferences as indicated in a personal profile of the user, the system comprising:
a processing device arranged to retrieve a personal profile from a personal unit, to process the personal profile to sort out the most suitable links or information, and to arrange the links or information into a list in the processing device in accordance with user's preferences as stored in the personal profile; and
a display for displaying the list of links or information to the user.

31. A system according to claim 30, wherein the processing device is one of the following: a mobile terminal, a computer, or a digital-TV terminal.

32. A system according to claim 30 or 31, wherein the display is a mobile terminal display, a computer monitor, or a television screen.

33. A method for providing recommendations for links to a user, the method comprising:
initiating a request for a service by the user;
providing a personal profile, which stored in a personal unit of the user, together with the request to a service provider;
processing the personal profile by the service provider;
comparing the personal profile to other users' personal profiles by the service provider;
selecting the users with matching personal profile as reference users; and
providing a link or links to other services based on the reference users' choices for next service to the user.

34. A method according to claim 33, wherein the service is a web page.

35. A system for providing recommendations for links to a user, the system comprising:
a user terminal for requesting a service and providing a personal profile from the personal unit together with the request to a service provider;
a service provider having processing means to process the personal profile, to compare the personal profile to other users' personal profiles and to select the users with matching personal profile as reference users and means for providing a link or links to other services based on the reference users' choices for next service to the user.
